(19) United States
(12) Patent Application Publication
(10) Pub. No.: US 2012/0077443 A1
(43) Pub. Date: Mar. 29, 2012

(54) MONITORING APPARATUS

(75) Inventors: Takeshi ISHIHARA, Kanagawa-ken (JP); Kotaro Ise, Kanagawa-ken (JP)

(73) Assignee: KABUSHIKI KAISHA TOSHIBA, Tokyo (JP)

(21) Appl. No.: 13/232,257

(22) Filed: Sep. 14, 2011

(30) Foreign Application Priority Data
Sep. 28, 2010 (JP) 2010-217269

(51) Int. Cl. H04B 17/00

(52) U.S. Cl. 455/67.11

(57) ABSTRACT

An monitoring apparatus according to an embodiment includes a first reception unit configured to receive a communication apparatus state transition notification indicating a state transition of a communication apparatus, a second reception unit configured to receive a network state transition notification indicating a state transition of a network, a determination unit configured to determine whether the state transition of the network is caused by the state transition of the communication apparatus, and a report notification unit, wherein when the determination unit determines that the state transition of the network is not caused by the state transition of the communication apparatus, the report notification unit transmits a report, and when the determination unit determines that the state transition of the network is caused by the state transition of the communication apparatus, the report notification unit does not transmits the report.

### CROSS-REFERENCE TO RELATED APPLICATION

The present invention claims benefit of priority of Japanese Patent Application No. 2010-217269 filed on Sep. 28, 2010. The contents of the application are incorporated into the present application by reference.

### FIELD

Embodiments of the present invention relates to a monitoring apparatus.

### BACKGROUND

In recent years, devices capable of going into sleep state are increasing. Since the device can go into the sleep state, power consumption can be reduced.

For example, when a device connected to a network goes into the sleep state, a signal sent from another device to the device in the sleep state does not reach the device in the sleep state while the device is in the sleep state. Therefore, a device for sending a response in reply to the signal on behalf of the device in the sleep state (proxy) is used.

When a device connected to a network changes the state between the sleep state and an activated state, there is a technique for confirming the state transition of the device into the sleep state.

However, for example, a system includes a device going into sleep state, a client computer, a relay apparatus (such as a switching hub and a router) interposed between these apparatuses, and an apparatus for monitoring the relay apparatus. In this system, the apparatus for monitoring the relay apparatus does not confirm transition of the device into the sleep state.

### BRIEF DESCRIPTION OF THE DRAWINGS

FIG. 1 is a figure illustrating a communication system according to a first embodiment;

FIG. 2 is a block diagram illustrating a configuration of a monitoring apparatus according to the first embodiment;

FIG. 3 is an example of information included in a network state transition notification stored in a storage unit;

FIG. 4 is an example of information stored in the storage unit, with which the monitoring apparatus operates/manages the network;

FIG. 5 is a block diagram illustrating a configuration of a communication apparatus according to the first embodiment;

FIG. 6 is a block diagram illustrating a configuration of a relay apparatus according to the first embodiment;

FIG. 7 is a block diagram illustrating a configuration of a state management apparatus according to the first embodiment;

FIG. 8 is a sequence diagram illustrating operation of a comparative example of a system according to the first embodiment;

FIG. 9 is a sequence diagram illustrating operation of the system according to the first embodiment;

FIG. 10 is a flowchart illustrating operation of the monitoring, apparatus according to the first embodiment;

FIG. 11 is a sequence diagram illustrating operation of a system according to a second modification of the first embodiment;

FIG. 12 is a block diagram illustrating a configuration of a monitoring apparatus according to a second embodiment;

FIG. 13 is information stored in a storage unit 807 of a monitoring apparatus according to the second embodiment;

FIG. 14 is a sequence diagram illustrating operation of a system according to the second embodiment;

FIG. 15 is a flowchart illustrating operation of a monitoring apparatus according to a modification of the second embodiment;

FIG. 16 is a block diagram illustrating a configuration of a monitoring apparatus according to a third embodiment;

FIG. 17A is an example of information included in a network state transition notification stored in a storage unit; and

FIG. 17B is an example of information, with which the network is operated/managed.

### DETAILED DESCRIPTION

A monitoring apparatus according to an embodiment includes a first reception unit configured to receive a communication apparatus state transition notification indicating a state transition of a communication apparatus between an activated state and a sleep state, a second reception unit configured to receive a network state transition notification indicating a state transition of a network, used for communication by the communication apparatus, between a communication enabled state and a communication disabled state, a determination unit configured to determine whether the state transition of the network is caused by the state transition of the communication apparatus, and a report notification unit, wherein when the determination unit determines that the state transition of the network is not caused by the state transition of the communication apparatus, the report notification unit transmits a report, and when the determination unit determines that the state transition of the network is caused by the state transition of the communication apparatus, the report notification unit does not transmits the report.

The one aspect of the present embodiment provides a monitoring apparatus capable of finding whether state transition of a network is caused by state transition of a device between sleep state and activated state in a system including the device that can change the state between the sleep state and the activated state.

Embodiments will be hereinafter explained with reference to the drawings.

### First Embodiment

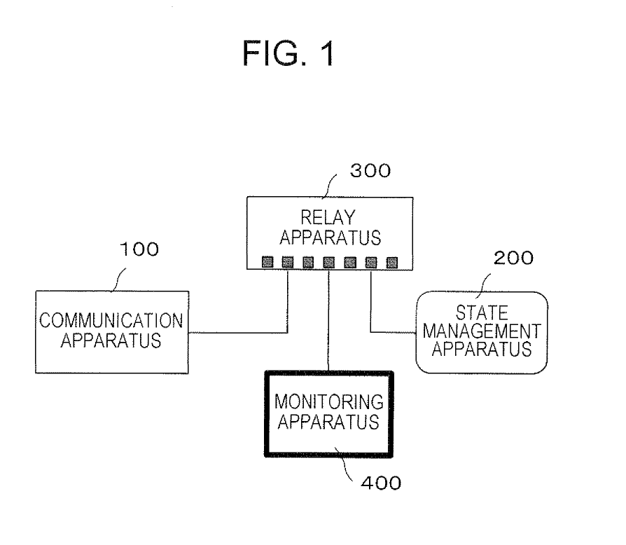

FIG. 1 is a figure illustrating a communication system according to a first embodiment.

The communication system includes a communication apparatus 100 capable of changing the state between sleep state and activated state, a state management apparatus 200 for managing the state of the communication apparatus 100, a monitoring apparatus 400 for monitoring failure occurring in a network and communication devices connected to the network, and a relay apparatus 300 connecting the communication apparatus 100, the state management apparatus 200, and the monitoring apparatus 400 with each other.

FIG. 1 shows only one communication apparatus 100. However, a plurality of communication apparatuses 100 may be connected. Likewise, a plurality of relay apparatuses 300 may be provided. The number of state management apparatuses 200 and the locations where the state management apparatuses 200 are installed are determined on the basis of correspondence with used communication protocols and network topology.

For example, when a communication protocol is configured to notify transition of a communication apparatus into sleep state within a single network (for example, within a subnet or a period in which a particular radio wave reaches), a state management apparatus is required in each network (each subnet or each radio wave propagation period). Alternatively, when a communication protocol is configured to send notification of transition into sleep state to a plurality of networks, at least one state management apparatus may be provided in a period in which the notification reaches).

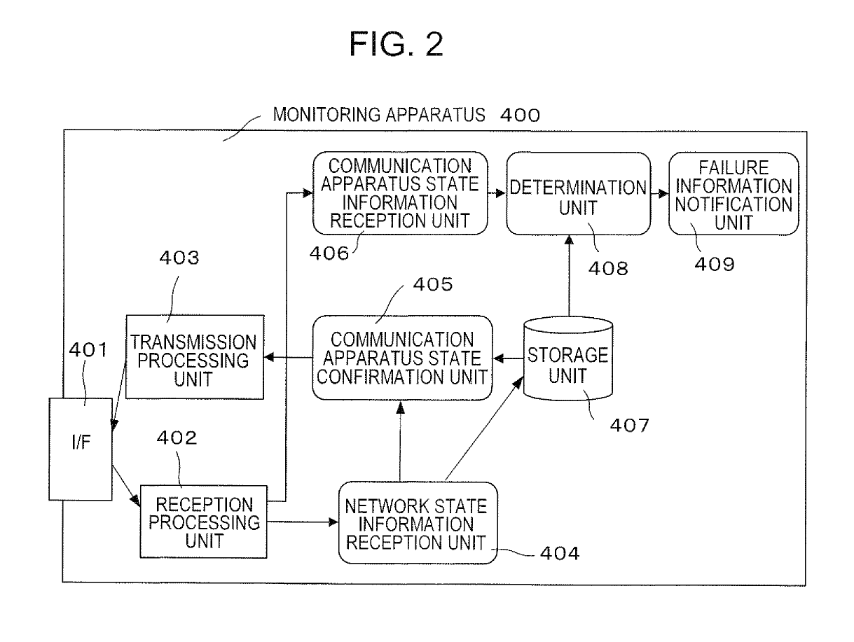

Subsequently, the monitoring apparatus 400 according to the first embodiment will be explained. FIG. 2 is a block diagram illustrating a configuration of the monitoring apparatus 400 according to the first embodiment.

A network interface 401 connects the monitoring apparatus 400 to a network. A reception processing unit 402 receives a packet via a network interface 401. A transmission processing unit 403 transmits a packet via a network interface 401.

A network state information reception unit 404 receives a network state transition notification, indicating state transition of a network used for communication by the communication apparatus 100, that changes the state between, communication enabled state and communication disabled state. For example, the network state transition notification is a notification of a link down and a link up of a port of the relay apparatus 300.

A communication apparatus state confirmation unit 405 notifies the state management apparatus 200 of a communication apparatus state transition confirmation notification indicating whether the communication apparatus 100 changed the state between the activated state and the sleep state. The communication apparatus state transition confirmation notification is a notification for confirming whether the communication apparatus 100 changed the state or not within a predetermined period of time before and after a time at which a network state transition occurred.

More specifically, the communication apparatus state transition confirmation notification includes, for example, “time at which network state transition occurs±predetermined time”. When the state management apparatus 200 receives the communication apparatus state transition confirmation notification, the state management apparatus 200 determines whether or not the communication apparatus changed the state in a period between the predetermined time before the time at which the network state transition occurred and the predetermined time after the time at which the network state transition occurred, and on the basis of the determination, the state management apparatus 200 sends a communication apparatus state transition response notification.

In this case, instead of the time at which the network state transition occurred, the communication apparatus state transition confirmation notification may include a time when the monitoring apparatus 400 received the network state transition notification and a time when information included in the network state transition (such as a time, an identifier of a relay apparatus, and the like) is stored in the storage unit 407. Alternatively, time at which the network state transition occurred±predetermined time may be configured such that a predetermined time added to the time at which the network state transition occurred may be different from a predetermined time subtracted from the time at which the network state transition occurred.

The communication apparatus state information reception unit 406 receives a communication apparatus state transition response notification in response to the communication apparatus state confirmation notification from the state management apparatus 200. For example, the communication apparatus state transition response notification is information indicating that the communication apparatus 100 changed the state between the activated state and the sleep state or information indicating that there is no state transition.

When the state management apparatus 200 stores information indicating that the communication apparatus changed the state between “the time at which the network state transition occurred−predetermined time” and “time at which the network state transition occurred+predetermined time”, the state management apparatus 200 sends a communication apparatus state transition response notification indicating that the communication apparatus changed the state. On the other hand, when the state management apparatus 200 does not store information indicating that the communication apparatus changed the state between “the time at which the network state transition occurred−predetermined time” and “time at which the network state transition occurred+predetermined time”, the state management apparatus 200 sends a communication apparatus state transition response notification indicating that the communication apparatus did not change the state.

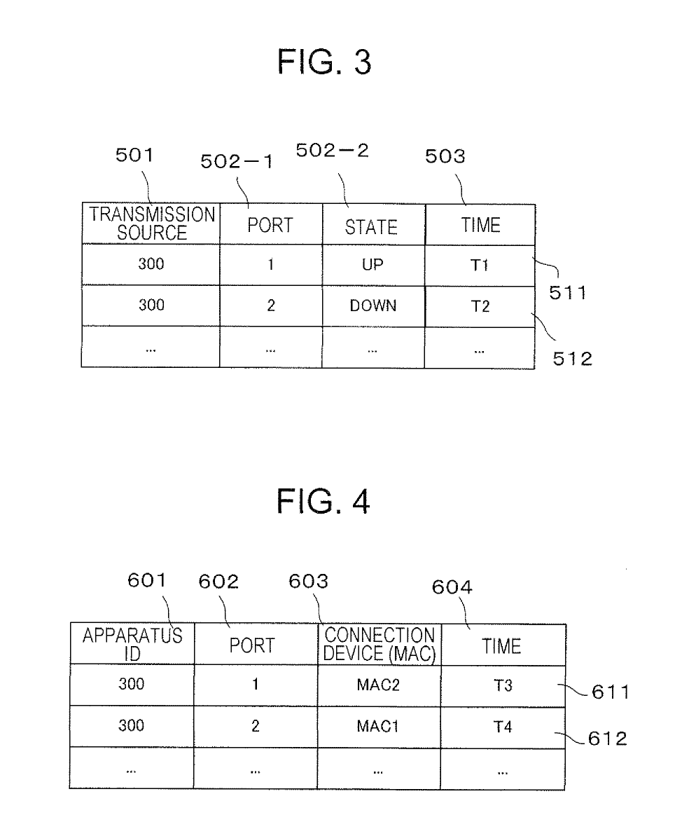

The storage unit 407 stores information included in the network state transition notification received by the network state information reception unit 404 and information with which the monitoring apparatus 400 operates/manages the network. Each of the above pieces of information will be explained with reference to FIGS. 3 and 4.

FIG. 3 is an example of information included in a network state transition notification stored in the storage unit 407 and received by the network state information reception unit 404. As shown in FIG. 3, the storage unit 407 stores an identifier of the relay apparatus 300, i.e., a source of the network state transition notification (column 501) and information notified in the network state transition notification (column 502).

In FIG. 3, the identifier of the relay apparatus 300 is denoted as 300. There are two pieces of information notified in the network state transition notification, i.e., a port number (column 502-1) and the state of port (502-2) of a relay apparatus 102. Further, a time at which the information of the network state transition notification is stored in the column 503.

It should be noted that the column 503 may also store a time when the information of the network state transition notification is notified and information included in the network state transition. Although not shown in the drawing, the network state transition notification may also include information about services (for example, identifiers identifying services such as URL and UUID). In FIG. 3, 1, 2 are shown as port numbers in the column 502-1.

For example, UP (link up), DOWN (link down) are shown as the states of ports in the column 502-2. In the above example, a layer 2 switch is used as an example for explanation. In the layer 2 switch, information such as up/down of port is transmitted to the monitoring apparatus.

The information about the network state transition notification stored in the storage unit 407 may be deleted in chronological order in accordance with the capacity of the storage unit 407, or may be moved to another storage unit (for example, an external storage unit such as a hard disk, not shown). However, the storage unit 407 stores at least information included in the latest network state transition notification and information that has not yet been processed by a determination unit 408.

FIG. 4 shows an example of information, i.e., the second information stored in the storage unit 407, with which the monitoring apparatus 400 operates/manages the network. In this example, the apparatus to be monitored by the monitoring apparatus 400 is the relay apparatus 300. The storage unit 407 stores information indicating which communication apparatus each port of the relay apparatus 300 is connected to. In FIG. 4, the relay apparatus 300 to be particularly monitored is a layer 2 switch. A column 601 includes an identifier of an apparatus to be monitored/managed (relay apparatus 300). A column 602 includes identifiers of ports constituting the relay apparatus 300 (which are denoted as 1, 2 in FIG. 4). A column 603 includes MAC addresses of the communication apparatuses connected to the ports (which are denoted as MAC 1, MAC 2 in FIG. 4). A column 604 includes times at which a series of information is recorded.

It should be noted that the monitoring apparatus 400 can structure the reformation as shown in FIG. 4 by obtaining forwarding tables and interface information from an MIB managed by the relay apparatus 300 (switch) using SNMP. Each state of port of the relay apparatus 300 can be obtained by obtaining a value of if OpenStatus included in IF-MIB of MIB-2. Correspondence between each port and the MAC address of the device can be obtained by using information of BRIDGE-MIS. In the case of the layer 3 switch, the correspondence with the IP addresses can also be obtained via SNMP, and therefore, the correspondence with the IP addresses may be included in the table of FIG. 4.

The determination unit 408 determines, on the basis of the communication apparatus state transition response notification received by the communication apparatus state information reception unit 406, whether the network state transition notification received by the network state information reception unit 404 is caused by the state transition of the communication apparatus and is not caused by network failure or caused indeed by network failure.

When the determination unit 408 determines that the state transition of the network is not caused by the state transition of the communication apparatus but is caused indeed by the network failure, a failure information notification unit 409 sends notification of failure report to the outside, e.g., a network administrator. On the other hand, when the determination unit 408 determines that the state transition of the network is caused by the state transition of the communication apparatus, the failure information notification unit 409 does not send notification of the failure information.

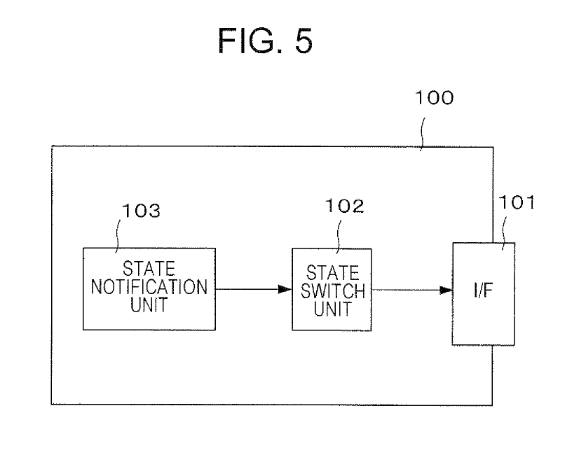

FIG. 5 is a block diagram illustrating a schematic configuration of the communication apparatus 100. A configuration of the communication apparatus 100 will be explained.

A network interface 101 connects the communication apparatus 100 to the network.

A state switch unit 103 switches the state of the communication apparatus 100 between the sleep state and the activated state.

When the communication apparatus 100 switches the state, the state notification unit 102 transmits a communication apparatus state transition notification indicating the state transition to the state management apparatus 200 via the network interface 101. In this case, the communication apparatus state transition notification is assumed to be sleep announcement indicating transition from the activated state to the sleep state or activation announcement indicating transition from the sleep state to the activated state.

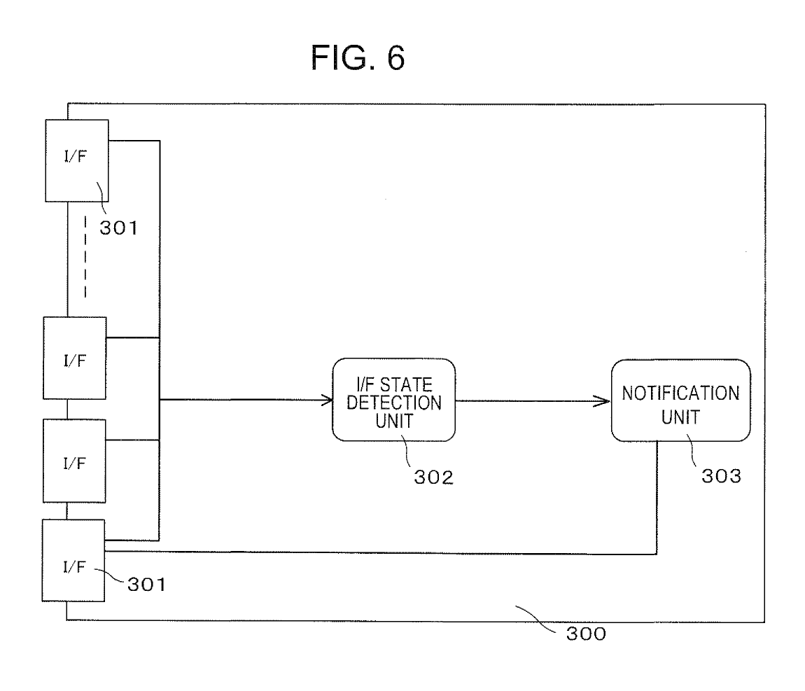

FIG. 6 is a block diagram illustrating a schematic configuration of the relay apparatus 300. The configuration of the relay apparatus 300 will be explained.

The relay apparatus 300 includes a plurality of interfaces (ports) 301.

An IF state detection unit 302 detects state transition of a port. In this case, the state transition of the port is a state transition between link down and link up of the port.

When the IF state detection unit 302 detects the state transition of the port, the notification unit 303 sends the network state transition notification to the monitoring apparatus 400. For example, the network state transition notification is a link up notification and a link down notification of the port.

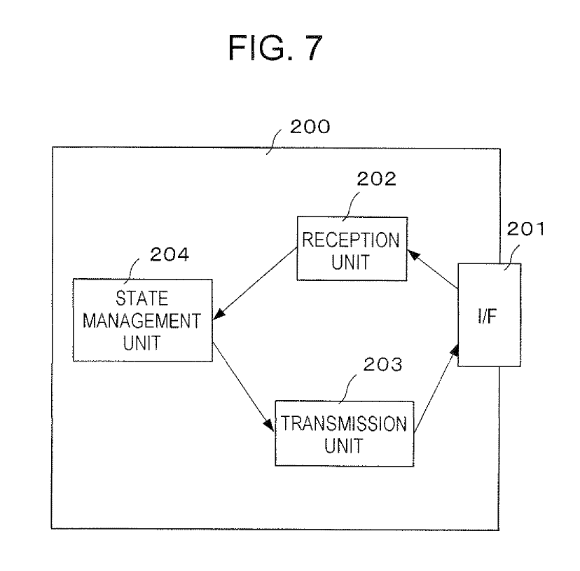

FIG. 7 is a block diagram illustrating a schematic configuration of the state management apparatus 200. The configuration of the state management apparatus 200 will be explained.

A network interface 201 connects the state management apparatus 200 to the network.

A reception unit 202 receives packets via a network interface 201. More specifically, the reception unit 202 receives a communication apparatus state transition notification from the communication apparatus 100. In addition, the reception unit 202 receives a communication apparatus state transition confirmation notification from the monitoring apparatus 400.

A transmission unit 203 transmits packets via the network interface 201. More specifically, the transmission unit 203 transmits a communication apparatus state transition response notification in response to a communication apparatus state transition confirmation notification.

A state management unit 204 manages the state of the communication apparatus 100. More specifically, for example, the state management unit 204 stores the MAC address of the communication apparatus, the state of the communication apparatus, and a time at which a communication apparatus state transition notification is received. Instead of the time at which the communication apparatus state transition notification is received, the state management unit 204 may store an occurrence time when the state management unit 204 has a time at which state transition of the communication apparatus occurs. The state management unit 204 may also store information about services provided by the communication apparatus 100 (for example, identifiers identifying services such as URL and UUID).

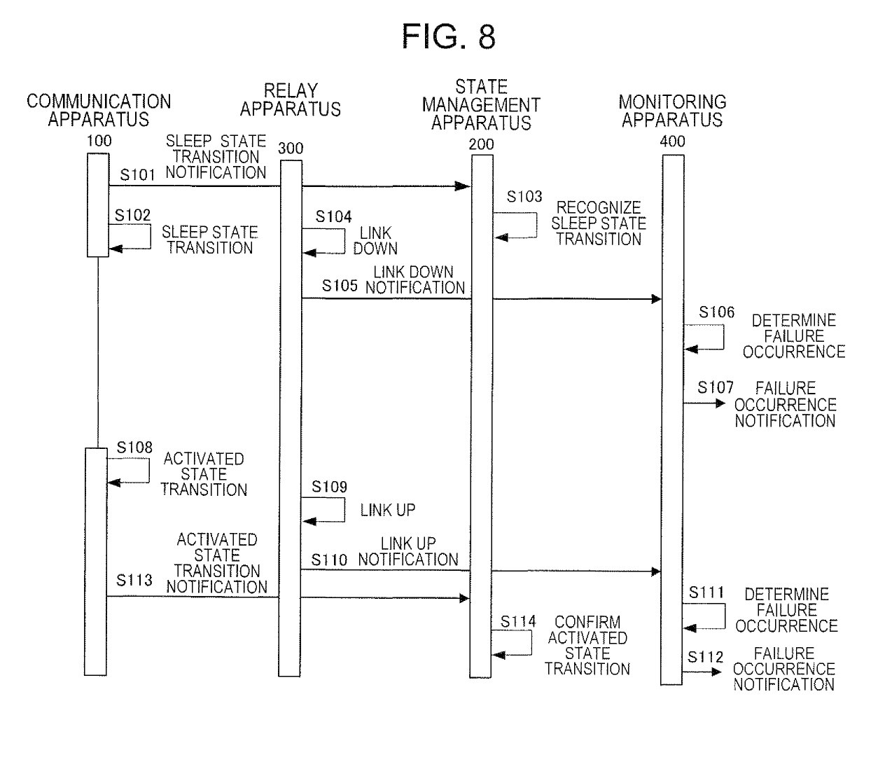

FIG. 8 is a sequence diagram illustrating operation of a comparative example of a system according to the first embodiment of the present invention. Hereinafter, the comparative example will be explained in order to explain the features of operation of the system according to the present embodiment.

In the sequence diagram of FIG. 8, a thin line indicates that a device is in the sleep state, and a thick frame portion indicates that a device is in operating state.

First, each apparatus is assumed to be connected to the network and in a state capable of communicating with each other. In this state, the communication apparatus 100 goes into the sleep state. Before going into the sleep state, the communication apparatus 100 sends, within the network, a communication apparatus state transition notification including information about transition to the sleep state (S101). In the explanation below, the communication apparatus state transition notification including information about transition to the sleep state will be referred to as sleep announcement. The sleep announcement is transmitted to, for example, the state management apparatus 200 set in advance via unicast. It should be noted that the sleep announcement may be transmitted via broadcast or multicast. In addition, it may be transmitted to apparatuses other than the state management apparatus 200 via unicast. After announcing the sleep announcement, the communication apparatus 100 actually goes into the sleep state (S102). When the communication apparatus 100 goes into the sleep state, the communication apparatus 100 is in an unreachable state from the network.

When the state management apparatus 200 receives the sleep announcement from the communication apparatus 100, the communication apparatus 100 recognizes that the communication apparatus 100 went into the sleep state (S103). When the sleep announcement is transmitted via multicast or broadcast, each of the other apparatuses constituting the network may be able to receive the sleep announcement in the same manner. However, the description thereabout is omitted.

When the communication apparatus 100 goes into the sleep state, the port of the relay apparatus 300 connected to the communication apparatus 100 changes to link down state. The relay apparatus 300 detects the link down of the port (S104). Then, the relay apparatus 300 sends notification of information including the link down of the port to the monitoring apparatus 400, as a network state transition notification (S105). In the explanation below, the network state transition notification including the information including the link down of the port will be referred to as link down notification.

When the monitoring apparatus 400 receives the link down notification, the monitoring apparatus 400 determines that failure occurs in the network (S106). Then, the monitoring apparatus 400 notifies the administrator of the occurrence of failure in the network (S107).

Subsequently, a case where the communication apparatus 100 restores from the sleep state the activated state will be explained. When the communication apparatus 100 changes the state from the sleep state to the activated state (S108), the port of the relay apparatus 300 changes to link up state (S109). When the port of the relay apparatus 300 changes to link up state, a network state transition notification including information about the link up of the port is notified to the monitoring apparatus 400 (S110). In the explanation below, the network state transition notification including the information about the link up of the port will be referred to as link up notification. When the monitoring apparatus 400 receives the link up notification, the monitoring apparatus 400 determines that failure occurs in the network (S111), the monitoring apparatus 400 notifies the administrator of the occurrence of failure in the network (S112). On the other hand, the communication apparatus 100 notifies the state management apparatus 200 of a communication apparatus state transition notification indicating that the communication apparatus 100 went into the activated state (S113), and the state management apparatus 200 confirms that the communication apparatus 100 has changed the state (S114). In the explanation below, the communication apparatus state transition notification indicating the transition to the activated state will be referred to as activation announcement.

As hereinabove explained, in the comparative example, the monitoring apparatus 400 monitoring the state of the relay apparatus 300 can find the link down (or link up) of a port of the relay apparatus 300, but cannot find that the link down (or link up) is caused by the transition of the communication apparatus 100 into the sleep state (or into the activated state). This is because the relay apparatus 300 cannot find that the communication apparatus 100 changed the state between the sleep state and the activated state. Therefore, in the comparative example, the monitoring apparatus 400 falsely detects network failure even though the link down (or link up) of the port of the relay apparatus 300 is caused by a normal state transition of the communication apparatus 100 into the sleep state (or into the activated state). As a result, occurrence of the network failure is notified to the administrator and the like in the outside, and this means that unnecessary network failure report is sent. In the above example, the communication apparatus state transition notification into the sleep state (or into the activated state) is transmitted via unicast, and accordingly, the monitoring apparatus 400 does not receive the notification. However, even if the communication apparatus state transition notification is transmitted via multicast or broadcast, the monitoring apparatus 400 falsely detects the link down (or link up) as network failure in the same manner when the monitoring apparatus 400 is unable to interpret the content of the notification.

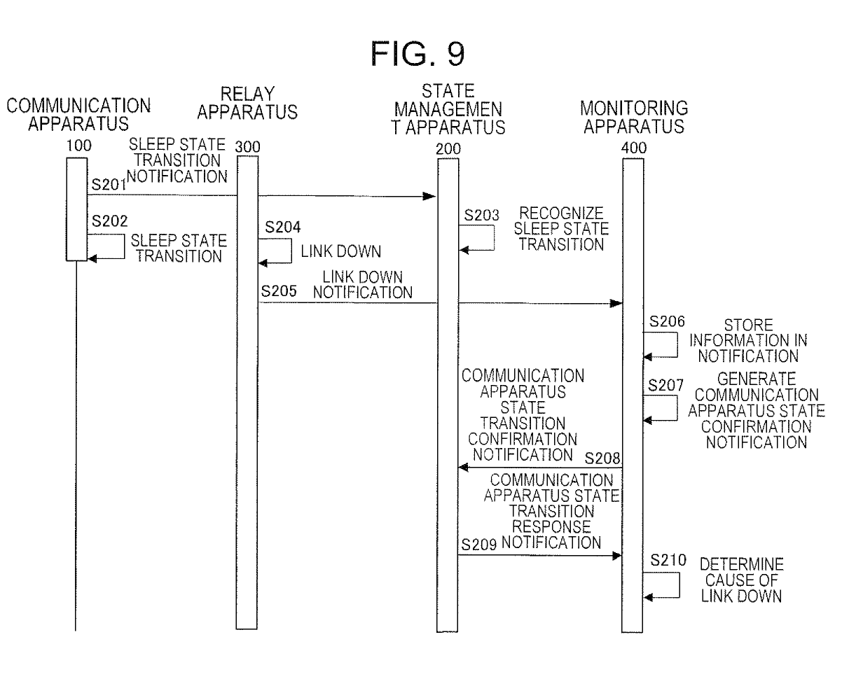

Subsequently, operation of the system according to the present embodiment will be explained while the system according to the present embodiment is compared with the comparative example. FIG. 9 is a sequence diagram illustrating operation of the system according to the first embodiment of the present invention.

Operations from step S201 to step S205 are the same as the operations from steps S101 to S105 explained with reference to FIG. 8, and therefore explanation thereabout is omitted.

When the monitoring apparatus 400 receives a link down notification, the monitoring apparatus 400 stores information included in the link down as well as a recording time of the information to the storage unit 407 as shown in FIG. 3 (S206). Subsequently, the communication apparatus state confirmation unit 405 of the monitoring apparatus 400 reads the recording time from the storage unit 407, generates a communication apparatus state transition confirmation notification, i.e., information including “recording time±predetermined time” (S207), and transmits the communication apparatus state transition confirmation notification to the state management apparatus 200 (S208). As described above, the state management unit 204 of the state management apparatus 200 received the sleep announcement from the communication apparatus 100, and stores the time when the sleep announcement was received. The state management apparatus 200 determines whether the time of reception of the communication apparatus state transition notification stored in the state management apparatus 200 is included between “recording time−predetermined time” and “recording time+predetermined time” included in the communication apparatus state transition confirmation notification received from the monitoring apparatus 400. When the time of reception of the communication apparatus state transition notification is determined to be included between “recording time−predetermined time” and “recording time+predetermined time”, the state management apparatus 200 sends a communication apparatus state transition response notification indicating that the communication apparatus 100 changed the state at a time between “recording time−predetermined time” and “recording time+predetermined time”. When the time of reception of the communication apparatus state transition notification is determined not to be included between “recording time−predetermined time” and “recording time+predetermined time”, the state management apparatus 200 sends a communication apparatus state transition response notification indicating that the communication apparatus 100 did not change the state. The monitoring apparatus 400 receives the communication apparatus state transition response notification (S209).

When the determination unit 408 of the monitoring apparatus 400 receives the communication apparatus state transition response notification, the determination unit 408 determines whether the link down of the port is caused by the state transition of the communication apparatus or not on the basis of the contents included in the communication apparatus state transition response notification (S210). More specifically, when the communication apparatus state transition response notification includes information indicating that the communication apparatus changed the state, the determination unit 408 of the monitoring apparatus 400 determines that the link down of the port is caused by the state transition of the communication apparatus, and when the communication apparatus state transition response notification does not include information indicating that the communication apparatus changed the state, the determination unit 408 determines that the link down of the port is not caused by the state transition of the communication apparatus. Then, when the monitoring apparatus 400 determines that the link down is caused by the state transition of the communication apparatus, the monitoring apparatus 400 terminates the processing. On the other hand, when the monitoring apparatus 400 determines that the link down is not caused by the state transition of the communication apparatus, the monitoring apparatus 400 causes the failure information notification unit 409 to notify the failure information notification unit 409 of a failure report indicating occurrence of network failure.

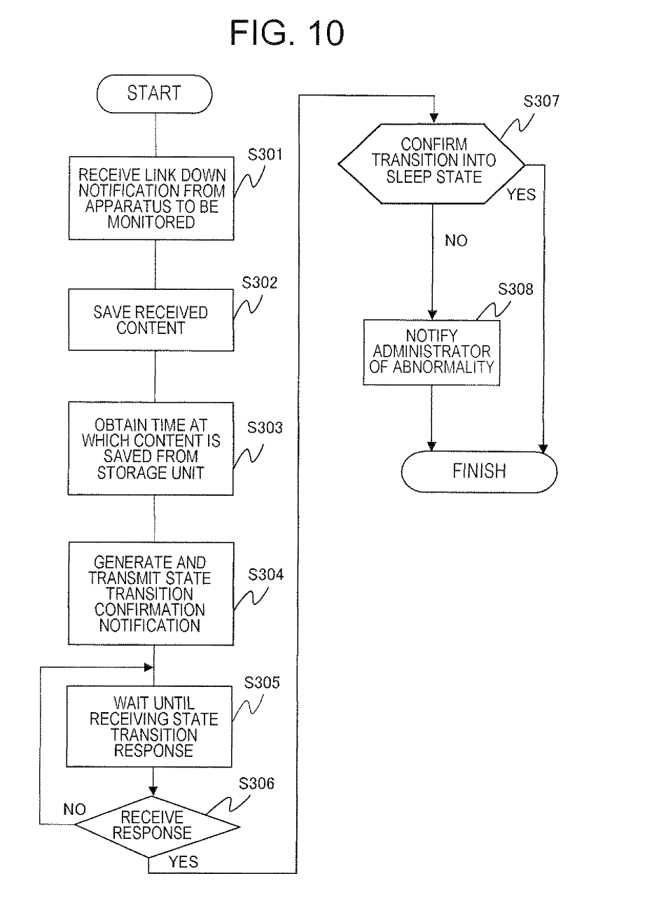

Subsequently, operation of the monitoring apparatus 400 in the processings from S205 to S209 in FIG. 9 will be explained in detail. FIG. 10 is a flowchart illustrating operation of the monitoring apparatus 400.

First, the reception processing unit 402 receives the link down notification transmitted from the relay apparatus 300 via the network interface 401 (S301). When the reception processing unit 402 confirms that a received packet is a notification transmitted from the relay apparatus 401, the reception processing unit 402 sends the packet to the network state information reception unit 404.

The network state information reception unit 404 analyzes the content of the notification, and saves the information about the port in the link down state and the storing time to the storage unit 407 (S302). For example, an entry 512 of FIG. 3 is generated. More specifically, identification information of a transmission source device (relay apparatus 300), an identifier of the port in the link down state, state of port (DOWN), and a recording time (T2) are recorded as the entry 512. Thereafter, the network state information reception unit 404 notifies the communication apparatus state confirmation unit 405 to request confirmation of the cause of the link down. At that occasion, the network state information reception unit 404 transmits, to the communication apparatus state confirmation unit 405, information for identifying the entry 512 as well as request of state confirmation of the communication apparatus. The information for identifying the entry 512 may be, for example, the transmission source device (the identification information of the relay apparatus 300) (column 501) and the port number of the port (column 502-1), or may be the recording time T2 or an identifier corresponding to the row 512. The network state information reception unit 404 may not necessarily sends notification of the information for identifying the entry 512. For example, when the communication apparatus state confirmation unit 405 is expected to request state confirmation of an entry whose recording time is the latest in the failure information stored in the storage unit 407.

When the communication apparatus state confirmation unit 405 receives the state confirmation request, the communication apparatus state confirmation unit 405 obtains the entry 512 and obtains the recording time T2 of the information about the port in the link down state from the storage unit 407 (S303). Then, the communication apparatus state confirmation unit 405 generates a communication apparatus state transition confirmation notification, and transmits the communication apparatus state transition confirmation notification to the state management apparatus 103 via the transmission processing unit 403 and the network interface 401 (S304). The communication apparatus state transition confirmation notification is information including “recording time T2±predetermined time”. The state management apparatus 200 determines whether the time of reception of the communication apparatus state transition notification stored in the state management apparatus 200 is included between “recording time−predetermined time” and “recording time+predetermined time” included in the communication apparatus state transition confirmation notification received from the monitoring apparatus 400. When the time of reception of the communication apparatus state transition notification is determined to be included between “recording time−predetermined time” and “recording time+predetermined time”, the state management apparatus 200 sends a communication apparatus state transition response notification indicating that the communication apparatus 100 changed the state at a time between “recording time−predetermined time” and “recording time+predetermined time”. When the time of reception of the communication apparatus state transition notification is determined not to be included between “recording time−predetermined time” and “recording time+predetermined time”, the state management apparatus 200 sends a communication apparatus state transition response notification indicating that the communication apparatus 100 did not change the state.

Thereafter, the monitoring apparatus 400 waits for the communication apparatus state transition response notification, i.e., a response to the communication apparatus state confirmation notification (S305). When the monitoring apparatus 400 receives the communication apparatus state transition response notification, the reception processing unit 402 receives the communication apparatus state transition response notification via the network interface 401 (S306: YES). When the reception processing unit 402 confirms that the communication apparatus state transition response notification is a response transmitted from the state management apparatus 103, the reception processing unit 402 sends the communication apparatus state transition response notification to the communication apparatus state information reception unit 406.

When the communication apparatus state information reception unit 406 receives the communication apparatus state transition response notification, the communication apparatus state information reception unit 406 stores the result to the storage unit 407. It should be noted that the communication apparatus state transition response notification may notified to the determination unit 408 without storing it to the storage unit 407. Thereafter, a request of determining the cause of the link down is sent to the determination unit 408.

The determination unit 408 reads information for determination from the storage unit 407, on the basis of the identification information of the apparatus of which determination is requested. More specifically, the information for determination includes information included in the network state transition notification of the apparatus identified by the identification information and information included in the communication apparatus state transition response notification. The details of the information for determination will be explained later.

Then, the determination unit 408 determines whether the detected link down is caused by the transition of the communication apparatus into the sleep state, on the basis of the information of the communication apparatus state transition response notification read from the storage unit 407. When the information of the communication apparatus state transition response notification is information indicating that the communication apparatus changed the state, the determination unit 408 determines that the link down is caused by the transition of the communication apparatus into the sleep state. On the other hand, when the information of the communication apparatus state transition response notification does not include information indicating that the communication apparatus changed the state, the determination unit 408 determines that the link down is not caused by the transition of the communication apparatus into the sleep state but is caused by network failure (S307).

When the determination unit 408 determines that the link down is caused by the transition of the communication apparatus into the sleep state (S307 YES), the monitoring apparatus 400 terminates the operation. On the other hand, when the determination unit 408 determines that the link down is not caused by the transition of the communication apparatus into the sleep state but is caused by network failure, the determination unit 408 gives a command to the failure information notification unit 409 to notify the administrator of a failure report. When the determination unit 408 determines that the link down is caused by network failure (S307 NO), the failure information notification unit 409 reads necessary information from the storage unit 407, and notifies the administrator of a failure report indicating network failure (S308). More specifically, the failure information notification unit 409 reads a corresponding entry from FIG. 3 using the recording time T2 explained above as a key, and obtains the port of which failure is reported (in this case, port 1). Further, the failure information notification unit 409 looks up FIG. 4 using the port 1 as a key, and identifies the identifier of the communication apparatus connected to the port 1 (in this case, MAC 1). On the basis of the above information, the failure information notification unit 409 sends notification of information about network failure (failure report) to the outside. It should be noted that the processings performed by the failure information notification unit 409 rely on the implementation. For example, the notification is sent as a transmission of an e-mail to the administrator or recording to a log file.

The monitoring apparatus 400 of the present embodiment can determine whether the state transition of the network found by the relay apparatus 103 is caused by the state transition of the communication apparatus. When it is caused by the state transition, no failure report is sent to the administrator, so that this prevents notification of unnecessary failure report from being transmitted to the administrator. In addition, the power-saving can be achieved in the network while the same network operation/management method as the currently used method is maintained.

Various kinds of communication protocols can be used as notifications when the relay apparatus 300 notifies the network state information reception unit 404 of the monitoring apparatus 400 of a link down and a link up as a network state transition notification. For example, SNMP can be used. Likewise, various kinds of communication protocols can be used as notifications transmitted and received by the communication apparatus state confirmation unit 405 and the communication apparatus state formation reception unit 406 and notifications used as communication apparatus state transition response notification. For example, SNMP and HTTP can be used.

In the above explanation, the relay apparatus 300 is the layer 2 switch. However, it may be a layer 3 switch, a router, and the like. In this case, the MAC address may be replaced with an appropriate identifier of each layer.

In the above explanation, for example, the communication apparatus changed the state from the activated state and the sleep state, and the link down of the port of the relay apparatus 300 is detected. The above explanation is also applicable when the communication apparatus changes the state from the sleep state to the activated state and the link up of the relay apparatus 300 is detected. However, in the case of the link up, the order of operation of the entire system as shown in the sequence diagram of FIG. 8 may be different from the case of the link down. More specifically, when the communication apparatus 100 changes the state to the sleep state, first, the state management apparatus 200 receives the communication apparatus state transition notification, and thereafter, the relay apparatus 300 detects the link down and sends notification thereabout. On the contrary, when the communication apparatus 100 changes the state from the sleep state to the activated state, first, the relay apparatus 300 detects the link up, and subsequently, the state management apparatus 200 receives the communication apparatus state transition notification. Therefore, in the case of the link up, if request for the state confirmation of the communication apparatus 100 is sent to the state management apparatus 200 immediately after the link up is detected, the state management apparatus 200 may not have finished processing the communication apparatus state transition notification. Therefore, it is preferable for the monitoring apparatus 400 to send the communication apparatus state transition confirmation notification after a certain period of time passes since the link up is detected.

Further, the functions of the determination unit 408 and the failure information notification unit 409 may be changed according to the communication apparatus connected to the network. For example, suppose a case where a communication apparatus without the function of sending notification of transition into the sleep state is known to exist beforehand. In this case, a table storing MAC addresses of excluded apparatuses is prepared in the storage unit 407, and the MAC addresses of the apparatuses incapable of sending notification of transition into the sleep state are registered in advance. When the determination unit 408 determines the cause of state transition of the network as explained above, the determination unit 408 performs not only the above processings but also processing for determining whether the MAC addresses included in the table are related to the state transition of the network or not. Then, when the communication apparatuses identified by the MAC addresses included in the table are related to the state transition of the network, the failure information notification unit 409 is not requested to transmit failure information notification regardless of the notification of the state transition of the network. On the contrary, when the MAC addresses included in the table are related to the state transition of the network, it may be configured such that transmission of notification is always requested. Further, the above MAC address table may be expanded so that it is saved as a table in which the MAC addresses and correspondences thereof are associated with each other.

For example, the monitoring apparatus 400 may be achieved by using a general-purpose computer apparatus as basic hardware. In other words, the network interface 401, the reception processing unit 402, the transmission processing unit 403, the network state information reception unit 404, the communication apparatus state confirmation unit 405, the communication apparatus state information reception unit 406, the storage unit 407, the determination unit 408, and the failure information notification unit 409 can be achieved by causing the processor implemented on the above computer apparatus to execute a program. At this occasion, the monitoring apparatus 400 may be realized by installing the program in the computer apparatus in advance or may be realized by storing the program in a storage medium such as a CD-ROM or distributing the program via a network and installing the program in the computer apparatus as appropriate. The storage unit 407 can be realized by using a storage medium or the like such as a memory incorporated in or externally attached to the computer apparatus, a hard disk, or a CD-R, a CD-RW, a DVD-RAM, or a DVD-R as appropriate.

### (First Modification)

Subsequently, a communication system according to a first modification of the first embodiment of the present invention will be explained.

In a communication system according to the first modification, the content of a communication apparatus state transition confirmation notification transmitted from a communication apparatus state confirmation unit 405 is different from the content of a communication apparatus state transition response notification received by a communication apparatus state information reception unit 406. Accordingly, the processing of the determination unit 408 is different.

More specifically, the communication apparatus state transition confirmation notification is a notification for inquiring the latest occurrence time of the state transition of a communication apparatus managed by a state management apparatus 200. When the state management apparatus 200 receives the communication apparatus state transition confirmation notification, the state management apparatus 200 transmits a notification of the latest occurrence time of the state transition as the communication apparatus state transition response notification. Then, the communication apparatus state information reception unit 406 of the monitoring apparatus 400 receives the communication apparatus state transition response notification. Then, the determination unit 408 compares the time included in the communication apparatus state transition response notification and the time at which the network state transition notification received by the network state information reception unit 404 is received, and determines whether the difference therebetween is more than a predetermined threshold value or not. The determination unit 408 determines whether the network state transition is caused by the state transition of the communication apparatus or not on the basis of the above determination. The processings other than the above are the same as those explained in the first embodiment, and description thereabout is omitted.

### (Second Modification)

Subsequently, a communication system according to a second modification of the first embodiment of the present invention will be explained.

In the communication system according to the second modification, the communication apparatus state confirmation unit 405 generates a communication apparatus state transition confirmation notification including not only “time at which the network state transition occurred±predetermined time” but also an identifier (MAC address) of a communication apparatus connected to a port in which a state transition of network occurred, and sends the communication apparatus state transition confirmation notification. Based on the communication apparatus state transition confirmation notification, the state management apparatus 200 sends a communication apparatus state transition response notification indicating occurrence of the state transition caused by the communication apparatus not only on the basis of a condition that the communication apparatus changed the state at a time between “time at which the network state transition occurred−predetermined time” and “time at which the network state transition occurred+predetermined time” but also on the basis of a condition that the communication apparatus identified by the MAC address in the notification stores information indicating that the communication apparatus changed the state.

In the explanation below, specific processings performed in the communication system according to the present modification will be explained.

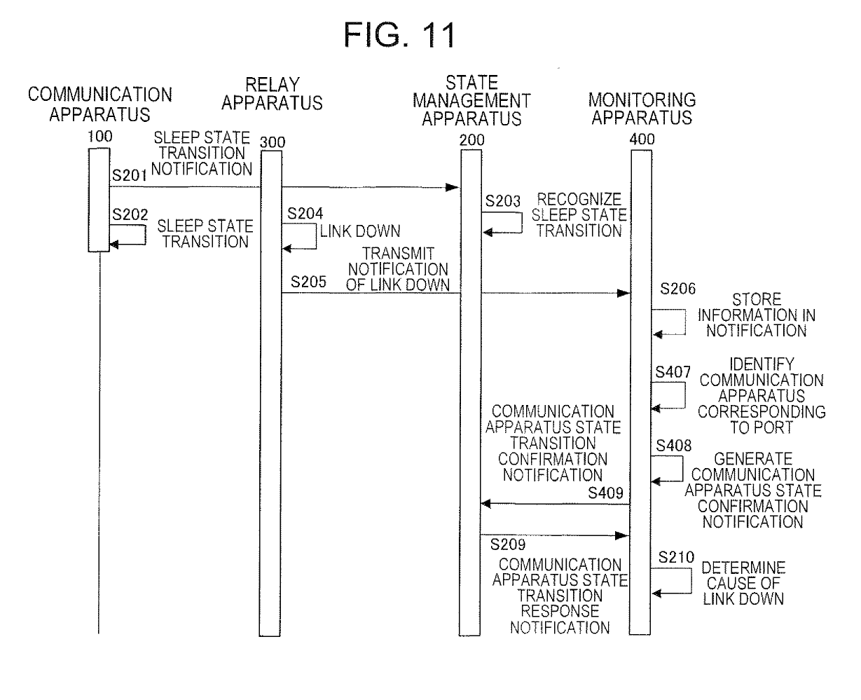

FIG. 11 is a sequence diagram illustrating operation of a monitoring apparatus 400 in a communication system according to the second modification of the first embodiment.

Operations from step S201 to step S206 are the same as those explained in the first embodiment, and accordingly, are denoted with the same numbers.

When the monitoring apparatus 400 receives a link down notification, the monitoring apparatus 400 identifies the communication apparatus connected to the port (S407).

In the explanation below, in S407, the method used by the monitoring apparatus 400 to identify the communication apparatus connected to the port will be explained.

It is assumed that a network state information reception unit 404 receives a link down notification from a relay apparatus 104, and information about the link down notification is stored in a storage unit 407. For example, an entry 512 of FIG. 3 is generated. More specifically, identification information of a transmission source device (relay apparatus 300), an identifier of the port in the link down state, state of port (DOWN), and a recording time (T2) are recorded as the entry 512. At that occasion, the network state information reception unit 404 transmits, to the communication apparatus state confirmation unit 405, information for identifying the entry 512 as well as request of state confirmation of the communication apparatus. When the communication apparatus state confirmation unit 405 receives the state confirmation request, the communication apparatus state confirmation unit 405 obtains the entry 512 from the information for identifying the entry 512, and obtains the port number connected to the communication apparatus to be confirmed. In this case, it is found that the port number is 2. Subsequently, the communication apparatus state confirmation unit 405 looks up the management information of FIG. 4, and obtains the identifier of the communication apparatus connected to the port having the port number 2. In this example, MAC 1 is obtained from an entry 612 as the identifier of the communication apparatus. According to the above method, the monitoring apparatus 400 can identify the communication apparatus connected to the port.

Subsequently, the communication apparatus state confirmation unit 405 of the monitoring apparatus 400 reads a recording time from the storage unit 407, and generates a communication apparatus state transition confirmation notification, i.e., information including “recording time predetermined time” and the MAC address of the communication apparatus identified in S407 (S408), and transmits the communication apparatus state transition confirmation notification to the state management apparatus 200 (S409). In this case, like what has been explained in the first embodiment, it is assumed that a state management unit of the state management apparatus 200 receives the communication apparatus state transition notification from the communication apparatus 100, and stores the time at which it is received. In this case, for example, the state management apparatus 200 determines whether the MAC address included in the communication apparatus state transition notification matches the MAC address of the communication apparatus 100, and further determines whether the time at which the communication apparatus state transition notification was received from the communication apparatus 100 is included in a period between “recording time−predetermined time” and “recording time+predetermined time” included in the communication apparatus state transition confirmation notification received from the monitoring apparatus 400. When the MAC addresses match each other, and the time is included therein, the state management apparatus 200 sends a communication apparatus state transition response notification indicating that the communication apparatus 100 changed the state. On the other hand, in cases other than the above, the state management apparatus 200 sends a communication apparatus state transition response notification indicating that the communication apparatus 100 did not change the state. The processing after this is the same as the processing of S209 explained in the first embodiment, and accordingly, explanation thereabout is omitted.

According to the communication system of the present modification, it is possible to reliably find that the communication apparatus in which the communication apparatus state transition occurred is the communication apparatus connected to the port in which the network state transition occurred. Therefore, a determination as to whether the state transition of the network is the state transition of the communication apparatus can be appropriately found.

In the present modification, the link down is explained. However, the link up can also be explained in the same manner.

### (Third Modification)

Subsequently, a communication system according to a third modification of the first embodiment of the present invention will be explained.

Like the first embodiment, in the communication system according to the third modification, a communication apparatus state confirmation unit 405 transmits notification of “time at which the network state transition occurred±predetermined time” as a communication apparatus state transition confirmation notification, and a state management apparatus 200 determines, on the basis of the communication apparatus state transition confirmation notification, whether a communication apparatus changed state at a time between “time at which the network state transition occurred−predetermined time” and “time at which the network state transition occurred+predetermined time”, and when the state transition occurred, the MAC address of the communication apparatus that changed the state is identified. Further, the communication state transition response notification includes not only information as to whether the communication apparatus changed the state at a time between “time at which the network state transition occurred−predetermined time” and “time at which the network state transition occurred+predetermined time” but also the MAC address of the communication apparatus when the state transition occurred. Then, when the determination unit 408 of the monitoring apparatus 400 receives a communication apparatus state transition response notification, a determination is made as follows. When the notification indicates that the communication apparatus changed the state and the MAC address in the notification matches the MAC address of the communication apparatus connected to the port in which the network state transition occurred, the determination unit 408 determines that the network state transition is caused by the state transition of the communication apparatus. On the other hand, in cases other than the above, the determination unit 408 determines that the network state transition is not caused by the state transition of the communication apparatus.

According to the communication system according to the present modification, it is possible to reliably find that the communication apparatus in which the communication apparatus state transition occurred is the communication apparatus connected to the port in which the network state transition occurred. Therefore, it is possible to more reliably find that the network state transition is caused by the communication apparatus state transition of the communication apparatus.

In the explanation below, specific processings performed in the communication system according to the present modification will be explained.

Operations from step S201 to step S205 are the same as those explained in the first embodiment, and therefore explanation thereabout is omitted. In this case, like what has been explained in the first embodiment, it is assumed that a state management unit of the state management apparatus 200 receives the communication apparatus state transition notification from the communication apparatus 100, and stores the time at which it is received. In this case, for example, when “recording time±predetermined time” included in the communication apparatus state transition notification indicates that the time at which the communication apparatus state transition notification was received from the communication apparatus 100 is included in a period between “recording time predetermined time” and “recording time+predetermined time”, the state management apparatus 200 transmits, as a communication apparatus state transition response notification, information indicating that the communication apparatus changed the state and the MAC address of the communication 100. On the other hand, when the state management apparatus 200 does not store information indicating that the state transition occurred in a period between “recording time−predetermined time” and “recording time+predetermined time”, the state management apparatus 200 transmits information indicating that the communication apparatus did not change the state as a communication apparatus state transition response notification.

When the determination unit 408 of the monitoring apparatus 400 receives the communication apparatus state transition response notification, the determination unit 408 determines whether the state transition of the network (the link down of the port) is caused by the state transition of the communication apparatus or not on the basis of the contents included in the communication apparatus state transition response notification. More specifically, first, a determination is made as to whether the communication apparatus state transition response notification includes information indicating that the communication apparatus changed the state. When the communication apparatus state transition response notification includes information indicating that the communication apparatus changed the state, a determination is made as to whether the MAC address included in the communication apparatus state transition response notification matches the MAC address of the communication apparatus connected to the port in which the state transition of the network occurred. When the communication apparatus state transition response notification includes the information indicating that the communication apparatus state transition occurred and the MAC address included in the communication apparatus state transition response notification matches the MAC address of the communication apparatus connected to the port in which the network state transition occurred, the determination unit 408 determines that the network state transition is caused by the state transition of the communication apparatus. In cases other than the above, the network state transition is not caused by the state transition of the communication apparatus, and then, when the monitoring apparatus 400 determines that the network state transition is caused by the state transition of the communication apparatus, the monitoring apparatus 400 terminates the processing. On the other hand, when the link down is determined not to be caused by the state transition of the communication apparatus, the failure information notification unit 409 transmits a notification that network failure occurred.

In the present modification, the link down is explained. However, the link up can also be explained in the same manner.

### Second Embodiment

Subsequently, a communication system according to a second embodiment of the present invention will be explained. A configuration of a communication system according to the second embodiment of the present invention is the same as the configuration of the communication system according to the first embodiment. More specifically, the communication system according to the second embodiment of the present invention includes a communication apparatus 100, a relay apparatus 300, a state management apparatus 200, and a monitoring apparatus 800. The communication system according to the second embodiment may not have the state management apparatus 300.

As compared with the monitoring apparatus 200 according to the first embodiment, the monitoring apparatus 800 according to the present embodiment is different in that the monitoring apparatus 800 does not confirm the state transition of the communication apparatus by contacting the state management apparatus 300, but the monitoring apparatus 800 directly receives the state transition of the communication apparatus from the communication apparatus 100. The configurations of the communication apparatus 100, the relay apparatus 200, and the state management apparatus 300 are the same as those explained in the first embodiment, and therefore explanation thereabout is omitted.

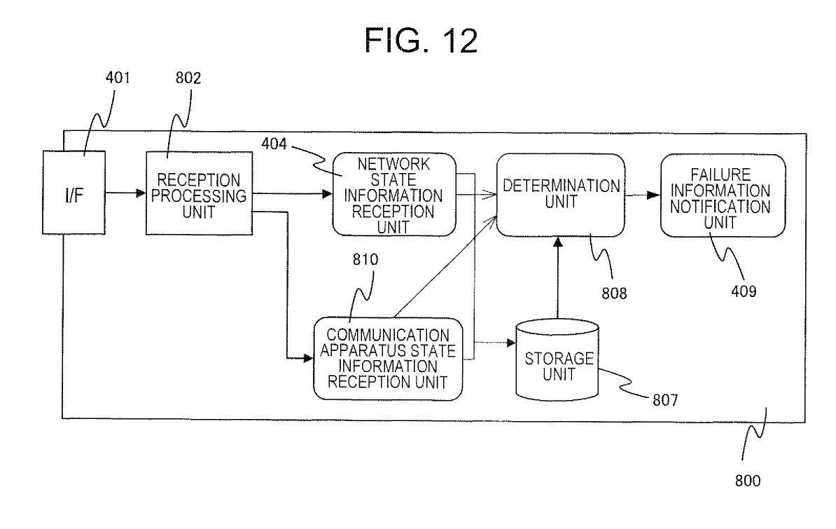

FIG. 12 is a block diagram illustrating a configuration of the monitoring apparatus 800. Constituent elements of the monitoring apparatus 800 having the same functions as those of the monitoring apparatus 400 explained in the first embodiment are denoted with the same numbers, and description thereabout is omitted.

Hereinafter, the configuration of the monitoring apparatus 800 will be explained with reference to FIG. 12.

Like a reception processing unit 402, a reception processing unit 802 receives a network state transition notification transmitted from the relay apparatus 300 via the network interface 401, and notifies the network state information reception unit 404. In addition, the reception processing unit 802 receives a communication apparatus state transition notification from the communication apparatus 100, and notifies a communication apparatus state information reception unit 810.

The communication apparatus state information reception unit 810 receives the communication apparatus state transition notification transmitted from the communication apparatus 100, and stores the information to a storage unit 807.

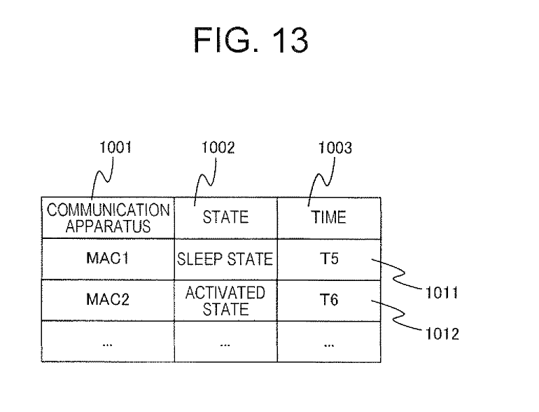

The storage unit 807 saves not only the information stored in the storage unit 407 of the first embodiment but also information about the communication apparatus state transition notification received from the communication apparatus 100. FIG. 13 illustrates an example of information about a communication apparatus state transition notification received from the communication apparatus. In FIG. 13, a column 1001 is an identifier of a communication apparatus transmitted a communication apparatus state transition notification (MAC address in FIG. 13), a column 1002 is a state of a communication apparatus (sleep state or activated state), and a column 1003 is a time at which the communication apparatus state transition notification is stored. In the example of FIG. 13, an entry in a row 1011 indicates that a communication apparatus state transition notification indicating transition into the sleep state is received from the communication apparatus identified by a MAC 1 at a time T5. An entry in a row 1012 indicates that a communication apparatus state transition notification indicating transition into the operating state is received from a communication apparatus identified by a MAC 2 at a time T6.

A determination unit 808 determines whether the network state transition is caused by the state transition of the communication apparatus or not on the basis of the network state transition notification and the communication apparatus state transition notification. More specifically, the determination unit 808 determines whether the network state transition is caused by the state transition of the communication apparatus or not on the basis of a time difference between the time when the network state transition notification was received and the time when the communication apparatus state transition notification was received.

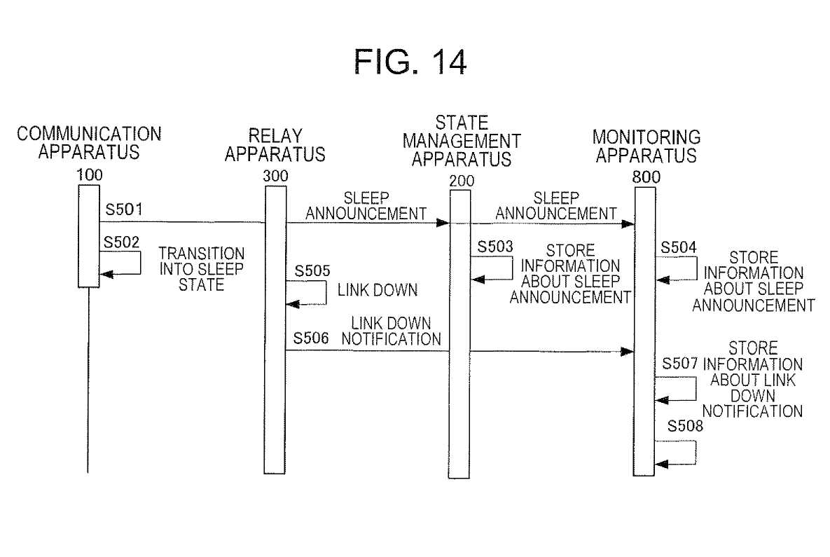

Subsequently, operation of the system according to the second embodiment of the present invention will be explained. FIG. 14 is a sequence diagram illustrating operation of a system according to the second embodiment of the present invention. In the explanation below, an example of transition from the activated state to the sleep state will be explained.

When the communication apparatus 100 goes into the sleep state, the communication apparatus 100 transmits a communication apparatus state transition notification including information indicating transition into the sleep state (hereinafter referred to as sleep announcement) to the entire network (S501). After the communication apparatus 100 transmits the sleep announcement, the communication apparatus 100 goes into the sleep state (S502). For example, the sleep announcement is transmitted to the entire network via multicast or broadcast. When the state management apparatus 200 exists on the network, the state management apparatus 200 receives the sleep announcement, and saves information about the sleep announcement (S503).

In addition, the monitoring apparatus 800 also receives the sleep announcement. The communication apparatus state information reception unit 810 of the monitoring apparatus 800 extracts the identifier of the communication apparatus 100 and the state of the communication apparatus 100 from the sleep announcement, and stores the identifier and the state to the storage unit 807 (S504). At this occasion, the time at which the identifier and the state are stored is also stored the storage unit 807. Thereafter, the communication apparatus state information reception unit 810 transmits notification of reception of the sleep announcement to the determination unit 808.

When the communication apparatus 100 goes into the sleep state, the port of the relay apparatus 300 changes to link down state. The relay apparatus 300 detects the link down of the port. Then, the relay apparatus 300 transmits the link down of the port as a network state transition notification (S506). In the explanation below, this network state transition notification will be referred to as link down notification. The link down notification includes the identifier of the port in which the link down occurred and the state thereof (link down). It should be noted that the link down notification may further include the occurrence time of the link down. The monitoring apparatus 800 extracts information included in the link down notification, and saves the information to the storage unit 807 (S507). At this occasion, the time at which it is stored in the storage unit 807 is also stored. When the occurrence time of the link down was received, the occurrence time may also be stored. Thereafter, the network state information reception unit 404 notifies the determination unit 808 of the reception of the link down notification.

The determination unit 808 calculates a time difference between the two notifications occurred previously (the link down notification and the sleep announcement). For example, the determination unit 808 calculates the time difference between the time at which the information about the link down notification was stored and the time at which the information about the sleep announcement was stored. Alternatively, when the time at which the link down notification occurred and the time at which the sleep announcement occurred are known, the determination unit 808 may calculate the time difference between these occurrence times. Then, when the time difference is determined to be less than a threshold value defined in advance, the determination unit 808 determines that the link down of the port of the relay apparatus 300 is caused by the transition of the communication apparatus 100 into the sleep state, and does not command the failure information notification unit 409 to notify the administrator of failure report. On the other hand, when the time difference is determined to be less than a threshold value defined in advance, the determination unit 808 determines that the link down of the port of the relay apparatus 300 is not caused by the transition of the communication apparatus 100 into the sleep state, and commands the failure information notification unit 409 to notify the administrator of failure report.

Subsequently, operation of the determination unit 808 of the monitoring apparatus 800 according to the present embodiment will be explained in detail. In the explanation below, two cases will be explained. In the first case, the relay apparatus 300 transmits notification of link down. In the second case, the relay apparatus 300 transmits notification of link up.

First, the case where the relay apparatus 300 transmits notification of link down will be explained.

When link down occurs in the relay apparatus 300, first, the communication apparatus state information reception unit 810 receives a sleep announcement from the communication apparatus, and subsequently, the network state information reception unit 404 receives a link down notification. The communication apparatus state, information reception unit 810 stores information about the sleep announcement to the storage unit 807 as the entry 1011 of FIG. 13. Thereafter, like the first embodiment, when the network state information reception unit 404 receives the notification of link down, the network state information reception unit 404 stores the notification to the storage unit 807 as the entry 512 of FIG. 3, and notifies the determination unit 808 of the notification of link down.

The determination unit 808 extracts the identifier of the port from the information included in the entry 512 of FIG. 3, and extracts the MAC address MAC 1 of the target device on the basis of the identifier of the port and the management information stored in the storage unit 807 (information as shown in FIG. 4). In this case, the target device means the communication apparatus connected to the port. After the MAC address MAC 1 of the target device is extracted, the determination unit 808 uses the MAC 1 to obtain the entry 1011 by searching the information in FIG. 13. Through the above operation, it is understood that the determination unit 808 receives the sleep announcement at a time T5 and receives the link down notification at a time T2 as shown in FIGS. 3 and 13.

The determination, unit 808 calculates a difference between the times T2 and T5, and determines whether the difference is more than a predetermined threshold value. More specifically, the determination unit 808 compares magnitude relation of T<|T2−T5| (T is a threshold value defined in advance, and a symbol |X| is the absolute value of X). When the absolute value of the difference between T2 and T5 is equal to or less than a threshold value T, the determination unit 808 determines that the link down notification and the sleep announcement are related to each other, and the link down is caused by the transition, of the communication apparatus into the sleep state. In this case, the determination unit 808 terminates the processing without notifying the failure information notification unit 409 of failure report. On the other hand, when the absolute value of the difference between T2 and T5 is more than the threshold value T, the determination unit 808 determines that the link down is not caused by the transition into the sleep state. Then, the determination unit 808 commands the failure information notification unit 409 to notify the administrator of failure report.

Subsequently, the case where the relay apparatus 300 transmits notification of link up will be explained.

When link up occurs in the relay apparatus 300, first, the network state information reception unit 404 receives a link up notification from the relay apparatus 300, and subsequently, the communication apparatus state information reception unit 810 receives a signal indicating transition into the activated state as a communication apparatus state transition notification from the communication apparatus (hereinafter referred to as activation announcement). When the network state information reception unit 404 receives the link up notification, the network state information reception unit 404 stores the information about the link up notification to the storage unit 808 as an entry 511 of FIG. 3. Thereafter, the determination unit 808 is notified of the link up notification.

When the determination unit 808 is notified of the link up notification from the network state information reception unit 404, the determination unit 808 recognizes the link up, and waits for notification of reception of an activation announcement from the communication apparatus state information reception unit 810 for a predetermined period of time. It should be noted that the determination unit 808 may immediately resume subsequent processing as soon as the determination unit 808 receives the notification. Alternatively, the predetermined period of time may be measured with a timer and the like, and after the predetermined period of time passes, the determination unit 808 may check whether there is a notification or not and continue the processing, during which time, the monitoring apparatus 800 may be configured to perform other processings.

When a certain period of time passes after the network state information reception unit 404 receives the notification of link up, the communication apparatus state information reception unit 810 receives the activation announcement from the communication apparatus. The communication apparatus state information reception unit 810 saves information corresponding to the entry 1012 of FIG. 13 as the information about the activation announcement. Thereafter, the communication apparatus state information reception unit 810 notifies the determination unit 808 of reception of the activation announcement.

When the determination unit 808 receives the notification of reception of the activation announcement, the determination unit 808 reads the information about the entry 1012 in FIG. 13 from the storage unit 807, and obtains MAC 2 as the identifier of the communication apparatus that changed the state and obtains T6 as the time at which the activation announcement was received. Subsequently, the monitoring apparatus 800 obtains an entry 611 corresponding to the MAC 2 from the management information as shown in FIG. 4. Then, 1 is obtained from the entry 611 as the identifier of a port in which link up event may occur. Further, the determination unit 808 searches the information saved by the network state information reception unit 404 (FIG. 3), and obtains the entry 511 corresponding to the port 1. Then, a time T1 at which the port 1 changed to linkup state is obtained from this entry.

Then, the determination unit 808 calculates the difference between T6 and T1, and determines whether an absolute value of a difference between T6 and T1 is more than a predetermined threshold value T. It should be noted that T may be the same as the threshold value used for the case of the link down. When the absolute value of the difference between T6 and T1 is equal to or less than a threshold value T, the determination unit 808 determines that the link up notification and the activation announcement are related to each other, and the link up of the port of the relay apparatus 300 is caused by the transition of the communication apparatus into the activated state. Then, the determination unit 808 terminates the processing without commanding the failure information notification unit 409 to transmit failure report. On the other hand, when the absolute value of the difference between T6 and T1 is more than the threshold value T, the determination unit 808 determines that the link up notification and the activation announcement are not related to each other, and the link up of the port of the relay apparatus 300 is not related to the transition of the communication apparatus into the activated state. Accordingly, the determination unit 808 determines that the linkup is an illegal link up. Then, the determination unit 808 commands the failure information notification unit 409 to notify the administrator of failure report indicating the illegal link up. It should be noted that the determination unit 808 also determines that an illegal link up occurred when the determination unit 808 does not receive the notification about the state transition from the communication apparatus state information reception unit 810 within a predetermined period of time after the reception of the link up notification. In such case, the determination unit 808 causes the failure information notification unit 409 to transmit a failure report indicating the illegal link up.

When the state transition of the network is caused by the state transition of the communication apparatus, the monitoring apparatus 800 according to the present embodiment can find this fact, and does not detect the state transition of the network as network failure. Accordingly, no failure report is transmitted to the administrator in the outside, so that this prevents transmission of unnecessary failure report.

In the above series of procedure, only one of the network state transition notification and the communication apparatus state transition notification is detected, operation of the determination unit 808 in making determination is different according to the information.

For example, when a sleep announcement is received as a network state transition notification but a notification of link down is not received, the determination unit 808 determines that a communication apparatus can maintain link even in the sleep state, and therefore, the determination unit 808 does not cause the failure information notification unit 409 to notify the administrator of failure information. On the other hand, when a link up notification is received but no activation announcement is received, the determination unit 808 determines that this is an illegal link up, and causes the failure information notification unit 409 to notify the administrator of a failure report indicating the illegal link up.

As explained in the first embodiment, for example, processing for treating the apparatuses differently according to the MAC addresses may be added. More specifically, for example, MAC addresses of communication apparatuses that do not transmit any sleep announcement even when they go into the sleep state are stored in a table. When a communication apparatus identified by a MAC address included in the table is related to state transition of the network, the failure information notification unit 409 is not requested to transmit failure information notification regardless of the notification of the state transition of the network.

In the above explanation, the order of reception of the communication apparatus state transition notification and the network state transition notification is in a particular order. However, it is not necessary to receive them in the above order. That is, regardless of the order of reception, a determination may be made as to whether an absolute value of a difference between times of two entries, related to each other, of information received by the network state information reception unit 404 and the state information reception unit 810 is equal to or more than a predetermined period of time (threshold value). Then, the determination as to whether the absolute value is equal to or more than the predetermined period of time is used as a criterion when a determination is made as to whether a notification of failure is transmitted to the administrator via the failure information notification unit 409.

Further, for example, in the system according to the present embodiment, the monitoring apparatus 800 directly receives the communication apparatus state transition notification from the communication apparatus 100. Alternatively, the following implementation is also possible. The communication apparatus state transition notification may be once received from the communication apparatus 100 by the state management apparatus 200, and thereafter, the communication apparatus state transition notification may be re-transmitted to the monitoring apparatus 800.

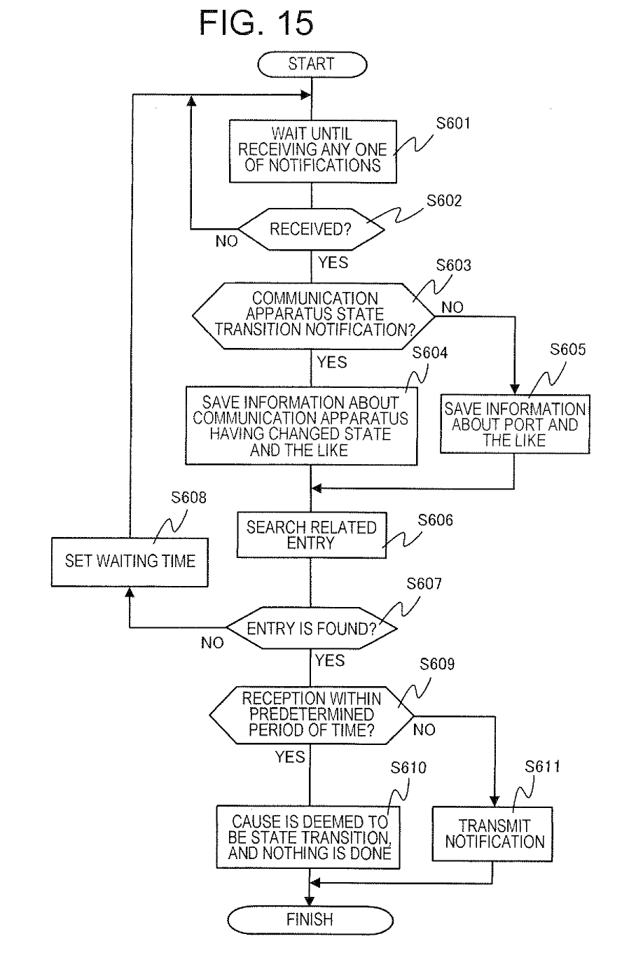

In the system according to the present embodiment, the determination unit determines whether the time difference between the time at which the communication apparatus state transition notification was received and the time at which the network state transition notification was received is more than the predetermined value or not by comparing the magnitude relation of the time difference between the times at which the notifications were received and the predetermined threshold value. However, the present embodiment is not limited thereto. For example, a certain period of waiting time may be provided after one of the communication apparatus state transition notification and the network state transition notification is received, and the determination may be made based on a determination as to whether the other notification is received within the waiting time. FIG. 15 shows an example of flowchart of operation of the monitoring apparatus 800 in such case.

### Third Embodiment

Subsequently, a monitoring apparatus 1200 according to a third embodiment of the present invention will be explained.

The monitoring apparatus 1200 has not only a function of a relay apparatus but also a function of the monitoring apparatus 800 according to the second embodiment.

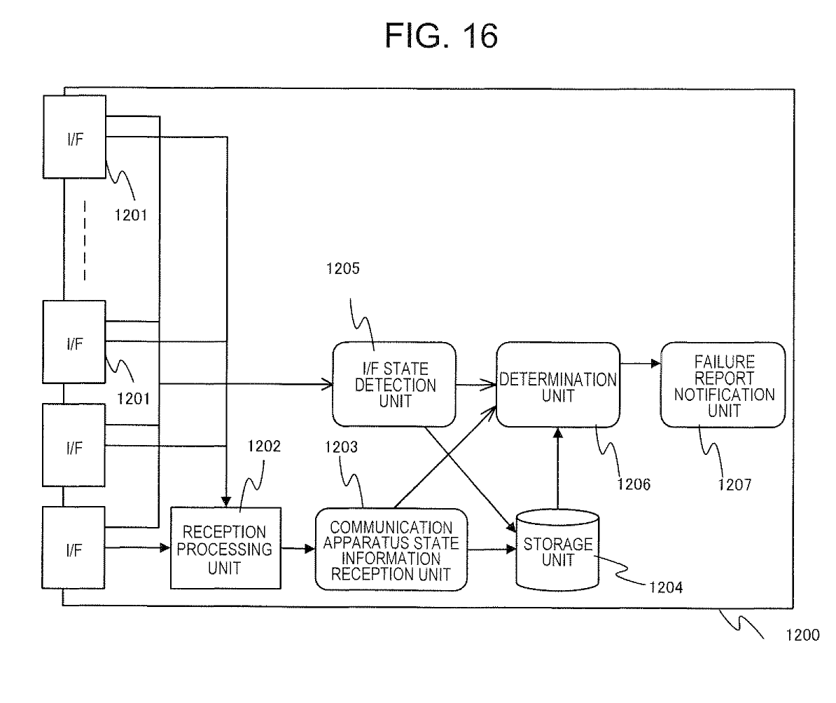

FIG. 16 is a block diagram illustrating the monitoring apparatus 1200 according to the third embodiment.

The monitoring apparatus 1200 is connected to a network via a plurality of network interfaces (ports) 1201.

The reception processing unit 1202 receives a packet addressed to the monitoring apparatus 1200 from among packets received by the network interfaces 1201.

A communication apparatus state information reception unit 1203 processes a communication apparatus state transition notification in the packet received by the reception processing unit 1202. More specifically, the communication apparatus state transition notification is stored in the storage unit 1204, and the determination unit 1206 is notified of the reception of the communication apparatus state transition notification.

An I/F state detection unit 1205 detects state transition of each network interface 1201. More specifically, state transition of each network interface (port) 1201 into link down or link up state is detected.

A storage unit 1204 stores information included in the communication apparatus state transition notification received by the communication apparatus state information reception unit 1203, information about the state transition of the network interface 1201 detected by the I/F state detection unit 1205, and information managed by the monitoring apparatus 1200. In this case, the information about the state transition of the network interface 1201 detected by the I/F state detection unit 1205 is information obtained by deleting information corresponding to a transmission source 501 (relay apparatus 300) from information saved in the storage unit 807 as shown in FIG. 3. The information received by the communication apparatus state information reception unit 1203 is the same information as the information as shown in FIG. 13. The information managed by the monitoring apparatus 1200 is information in columns 602 and 603 in FIG. 4.

The determination unit 1206 determines whether the state transition of the network interface 1201 is caused by the state transition of the communication apparatus or not, on the basis of the information about the state transition of the network interface 1201 detected by the I/F state detection unit 1205 and the information included in the communication apparatus state transition notification received by the communication apparatus state information reception unit 1203, stored in the storage unit 1204.

When the determination unit 1206 determines that the state change of the network interface 1201 is not caused by the state transition of the communication apparatus, the failure report notification unit 1207 notifies an external monitoring apparatus of the state change of the network interface 1201 as failure report.

Operation of the monitoring apparatus 1200 according to the present embodiment will be explained.

The operation of the monitoring apparatus 1200 is substantially the same as operation of the monitoring apparatus 800 according to the second embodiment. In the second embodiment, the network state transition notification is received by the network state information reception unit 404 from the outside. In contrast, the monitoring apparatus 1200 is different from the second embodiment in that the I/F state detection unit 1205 directly monitors the interface (port) 1201 of itself, and detects link down and link up. Operations other than the above are the same as those of the second embodiment, and description thereabout is omitted.

The monitoring apparatus 1200 of the present embodiment can determine whether the link down (or link up) of the monitoring apparatus 1200 is caused by the transition of the communication apparatus into the sleep state (or transition to the activated state). When it is caused by the transition into the sleep state (or transition into the activated state), no failure report is sent to the administrator, so that this prevents unnecessary failure report from being transmitted to the administrator.

In the explanation about the first to third embodiments, the determination unit determines that the network state transition is not caused by the state transition of the communication apparatus, failure report indicating occurrence of the network state transition is transmitted. However, the method of reporting is not related to this form. For example, reporting may be given by emitting sound, turning on an LED, and turning on a power source of an external device.

In the explanation about the first to third embodiments, the monitoring apparatus determines whether the state transition of the network is caused by the state transition of the communication apparatus between the activated state and the operating state, and when the state transition of the network is determined not to be caused by the state transition of the communication apparatus between the activated state and the operating state, failure report is transmitted and when the state transition of the network is determined to be caused by the state transition of the communication apparatus between the activated state and the operating state, failure report is not transmitted.

However, the monitoring apparatus can also be applied to examples other than the state transition of the network and the state transition of the communication apparatus between the activated state and the operating state as explained above. For example, when the monitoring apparatus receives an event ID for example, an identifier for identifying a service explained above) given from a relay apparatus, a related event corresponding to the event ID (a service provided by the communication apparatus) may be identified, and a determination can be made as to whether the related event occurs in the communication apparatus or not.

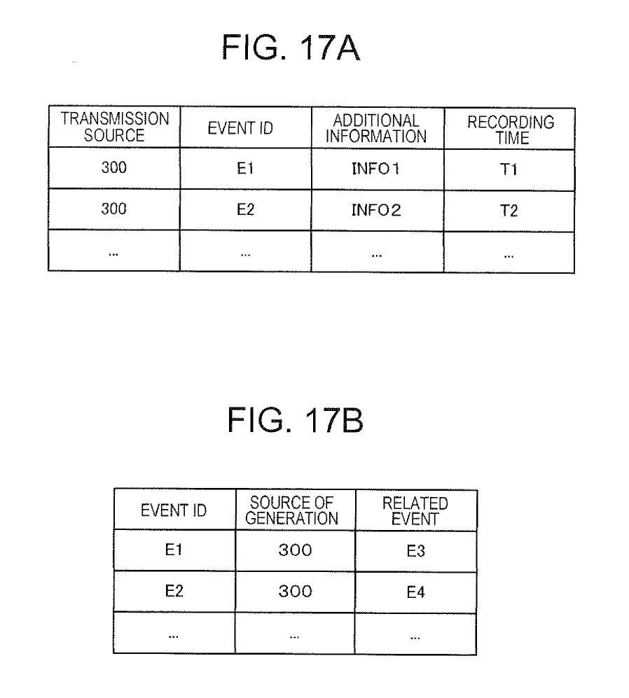

In this case, information included in a network state transition notification corresponds to the event ID, and information included in a communication apparatus state transition notification corresponds to a related event E3 FIG. 17A is an example of information included in a network state transition notification. FIG. 17B is an example information, with which the network managed by the monitoring apparatus is operated/managed. As shown in FIG. 17B, the monitoring apparatus stores correspondence between event IDs and related events.

When the monitoring apparatus receives a network state transition notification whose event ID includes E1, for example, the monitoring apparatus asks the state management apparatus if the related event E3 corresponding to the event ID E1 occurs. The monitoring apparatus determines whether a report is to be transmitted or not on the basis of a response from the state management apparatus, and transmits the report.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A monitoring apparatus comprising:
a first reception unit configured to receive a communication apparatus state transition notification indicating a state transition of a communication apparatus between an activated state and a sleep state;
a second reception unit configured to receive a network state transition notification indicating a state transition of a network, used for communication by the communication apparatus, between a communication enabled state and a communication disabled state;
a determination unit configured to determine whether the state transition of the network is caused by the state transition of the communication apparatus; and
a report notification unit, wherein when the determination unit determines that the state transition of the network is not caused by the state transition of the communication apparatus, the report notification unit transmits a report, and when the determination unit determines that the state transition of the network is caused by the state transition of the communication apparatus, the report notification unit does not transmits the report.

2. The monitoring apparatus according to claim 1, wherein when an absolute value of a difference between a time of the state transition of the communication apparatus and a time of the state transition of the network is more than a predetermined value, the determination unit determines that the state transition of the network is not caused by the state transition of the communication apparatus,
when the absolute value of the difference is equal to or less than the predetermined value, the determination unit determines that the state transition of the network is caused by the state transition of the communication apparatus.

3. The monitoring apparatus according to claim 2, wherein when an identifier identifying the communication apparatus in which the state transition occurs matches an identifier identifying a communication apparatus connected to the network in which the state transition occurs, the determination unit determines that the state transition of the network is caused by the state transition of the communication apparatus,
when the identifier identifying the communication apparatus in which the state transition occurs does not match the identifier identifying the communication apparatus connected to the network in which the state transition occurs, the determination unit determines that the state transition of the network is not caused by the state transition of the communication apparatus.

4. The monitoring apparatus according to claim 3, wherein the communication apparatus can communicate with a relay apparatus via the network, and the state transition of the network, used for communication by the communication apparatus, between the communication enabled state and the communication disabled state is due to a state transition between the communication enabled state and the communication disabled state of the network between the communication apparatus and the relay apparatus,
wherein when the relay apparatus detects a state transition between the communication enabled state and the communication disabled state of the network with the communication apparatus, the network state transition notification transmits the notification.

5. The monitoring apparatus according to claim 4, wherein the state trans it ion of the communication apparatus between the activated state and the sleep state is managed by a state management apparatus,
when the network state information reception unit receives the network state transition notification, the network state information reception unit transmits a communication apparatus state transition confirmation notification to the state management apparatus to ask whether the state transition occurred in the communication apparatus or not,
the communication apparatus state information reception unit receives the communication apparatus state transition notification which is a response to the communication apparatus state transition confirmation notification.

6. The monitoring apparatus according to claim 4, wherein the communication apparatus state information reception unit receives the communication apparatus state transition notification transmitted by the communication apparatus.

7. A monitoring apparatus comprising:
a communication apparatus state information reception unit for receiving a communication apparatus state transition notification indicating a state transition f a communication apparatus between an activated state and a sleep state;
an interface capable of communicating in a network used for communication by the communication apparatus;
an interface state detection unit for detecting a state transition of the network, used for communication by the communication apparatus, between a communication enabled state and a communication disabled state, on the basis of a determination as to whether the interface is capable of communication;
a determination unit for determining whether the state transition of the network is caused by the state transition of the communication apparatus; and
a report notification unit, wherein when the determination unit determines that the state transition of the network is not caused by the state transition of the communication apparatus, the report notification unit transmits a report, and when the determination unit determines that the state transition of the network is caused by the state transition of the communication apparatus, the report notification unit does not transmits the report.

8. A monitoring apparatus comprising:
a reception unit for receiving a communication apparatus state transition notification indicating a state transition of a communication apparatus between an activated state and a sleep state and receiving a network state transition notification indicating a state transition of a network, used for communication by the communication apparatus, between a communication enabled state and a communication disabled state;
a determination unit for determining whether the state transition of the network is caused by the state transition of the communication apparatus, on the basis of the communication apparatus state transition notification and the network state transition notification received by the reception unit; and
a report notification unit, wherein when the determination unit determines that the state transition of the network is not caused by the state transition of the communication apparatus, the report notification unit transmits a report.

9. The monitoring apparatus according to claim 8, wherein each of the communication apparatus state transition notification and the network state transition notification includes a time of the state transition thereof, and when a time difference between the time of the state transition of the communication apparatus and the time of the state transition of the network is equal to or more than a predetermined value, the determination unit determines that the state transition of the network is not caused by the state transition of the communication apparatus.

10. The monitoring apparatus according to claim 9, wherein when an identifier identifying the communication apparatus in which the state transition occurs does not match an identifier identifying a communication apparatus connected to the network in which the state transition occurs, the determination unit determines that the state transition of the network is not caused by the state transition of the communication apparatus.

11. The monitoring apparatus according to claim 8, wherein a state management apparatus managing a state of the communication apparatus receives the communication apparatus state transition notification from the communication apparatus, and when a state transition of the communication apparatus is detected via a relay apparatus connected to the communication apparatus, the state management apparatus is asked about the state transition of the communication apparatus, and the determination unit determines whether the state transition of the network is caused by the state transition of the communication apparatus, on the basis of a state transition response notification of the communication apparatus transmitted from the state management apparatus.

12. The monitoring apparatus according to claim 11, wherein each of the state transition response notification and the network state transition notification includes a time of the state transition thereof, and when a time difference between the time of the state transition of the communication apparatus and the time of the state transition of the network is equal to or more than a predetermined value, the determination unit determines that the state transition of the network is not caused by the state transition of the communication apparatus.

13. The monitoring apparatus according to claim 12, wherein when an identifier identifying the communication apparatus in which the state transition occurs does not match an identifier identifying a communication apparatus connected to the network in which the state transition occurs, the determination unit determines that the state transition of the network is not caused by the state transition of the communication apparatus.

14. A computer program product having a non-transitory computer readable medium including programmed instructions for outputting information, wherein, the instructions, when executed by a computer to perform:
receiving a communication apparatus state transition notification indicating a state transition of a communication apparatus between an activated state and a sleep state;
receiving a network state transition notification indicating a state transition of a network, used for communication by the communication apparatus, between a communication enabled state and a communication disabled state;
determining whether the state transition of the network is caused by the state transition of the communication apparatus; and
transmitting a report in determining that the state transition of the network is not caused by the state transition of the communication apparatus, and doing not transmit the report in determining that the state transition of the network is caused by the state transition of the communication apparatus.
